(19) United States
(12) Patent Application Publication
(10) Pub. No.: US 2025/0349210 A1
(43) Pub. Date: Nov. 13, 2025

(54) SIGNAL LIGHT PRIORITY SYSTEM UTILIZING VIDEO PROCESSING

(71) Applicant: STC, Inc., McLeansboro, IL (US)

(72) Inventor: Brad CROSS, McLeansboro, IL (US)

(21) Appl. No.: 19/201,466

(22) Filed: May 7, 2025

Related U.S. Application Data
(60) Provisional application No. 63/643,607, filed on May 7, 2024.

(51) Int. Cl. G08G 1/081; G06T 7/246; G06T 7/536; G06T 7/73; G06V 20/58; G08G 1/04; G08G 1/052; G08G 1/127

(52) U.S. Cl. CPC G08G 1/081; G06T 7/246; G06T 7/536; G06T 7/73; G06V 20/582; G06V 20/584; G08G 1/04; G08G 1/052; G08G 1/127; G06T 2207/30252

(57) ABSTRACT

Methods and systems for modifying a traffic flow control systems wherein a vehicle's real-time location and estimated time of arrival (ETA) is utilized to modify the priority management cycles of multiple traffic lights in a traffic grid, and the vehicle's real-time location and ETA are determined, at least in part, via the use of video processing.

### CROSS-REFERENCE TO RELATED APPLICATION(S)

This application claims benefit of U.S. Provisional Patent Application No. 63/643,607, filed on May 7, 2024, the entire disclosure of which is herein incorporated by reference.

### BACKGROUND OF THE INVENTION

### Field of the Invention

This disclosure is related to the field of systems for the management of traffic flow through the controlling of signal lights and monitoring the location of vehicles within a traffic grid. In many embodiments, one or more cameras may be used to determine the location of vehicles within a traffic grid, as well as the speed and estimated time of arrival for a given vehicle at or around a particular intersection or other location of interest.

### Description of the Related Art

In the perfect commuter utopia, signal lights would automatically switch to green every time a driver's vehicle approached an intersection, creating an unobstructed pathway towards the driver's final destination. In real life though, hitting a red light is a normal and inevitable part of any driver's commute. With the growth of modern cities and the reliance of much of the population on road-based mass transit and personal automobiles for transportation, efficient control of the ebb and flow of traffic through efficient and smart signal light control and coordination systems has become increasingly important.

Older control systems for signal lights were generally passive, relying on timers to control when each signal light changes between the three available colors (red, yellow, and green). These systems were acceptable, but may result in any given driver arriving at a signal light having to wait for a longer period than is necessary. This delay is primarily due to the inability of timers to react to what is occurring around the signal lights. As a result, dynamic systems that can react to the setting around the lights, or to another input, have been implemented.

Many of these dynamic systems generally use detectors to allow the system to react to its setting, the detectors generally being grouped into four main classes: in-pavement detectors, non-intrusive detectors, detectors for non-motorized road users, and priority-based systems using on-board vehicle equipment units/vehicle computer units (“VCUs”). On-board VCUs (or a mobile phone, or the like) may be used to determine a given vehicle's priority in the traffic grid, and when in communication with the traffic grid, may assist the traffic system in managing lights throughout the traffic system.

However, these dynamic traffic control systems also have disadvantages. For example, some prior dynamic systems are typically limited in their ability to prioritize, and tend to attempt to maximize throughput through a certain region of a traffic system or through the traffic system as a whole. This focus on throughput may limit the dynamic system's ability to provide ideal traffic patterns for many types of mass transit vehicles, such as buses. This may be because a bus needs to arrive at its destination, or bus stop, within a certain time window. Being too early, were a traffic system prioritize the bus to get it to its next destination as fast as possible, may be a problem for a bus that is trying to remain on its schedule.

To alleviate such problems, some traffic control systems use an estimated time of arrival, (“ETA”) or other methodology to improve on the assignment of priority to particular vehicles. Such systems are disclosed in, for example, U.S. Pat. Nos. 8,878,695; 9,953,522; and 11,202,302, the disclosures of which are hereby incorporated into this Application by reference in their entirety. ETA-based systems are relatively effective in practice. For example, such systems are able to adjust traffic signal patterns to prioritize vehicles within the traffic grid while simultaneously providing traffic patterns to keep mass transit vehicles, or even subsets of other vehicles within the traffic grid, on time. However, even modern ETA-based systems have a number of disadvantages that persist. For example, these systems tend to be overly reliant on (1) on-board computing systems and (2) satellite-based location determinations. The first issue revolves around hardware compatibility for the system as a whole, and the second issue is centered on some technical limitations of satellite-based location services.

For the first issue related to on-board computing systems, such as VCUs, while VCUs are powerful and capable, they are also often inflexible at least partially because they tend to only be compatible with specific traffic control systems. For example, a VCU purchased from Company A may only function together with other traffic monitoring and related equipment provided by Company A. Thus, if a given jurisdiction in charge of a traffic grid decided to purchase traffic controller equipment from Company B, the jurisdiction's VCUs purchased from Company A may no longer function. Further, such single-vendor solutions may have the problem that prices may be artificially increased due to demand for more parts within that single solution caused by the costs already sunk into investments in other portions of the system. Further, where there is only one vendor, the traffic grid may risk problems that could occur if the single vendor was unable or unwilling to provide reasonably priced maintenance or new/replacement parts. Other interoperability problems may also be present. In any case, there can be many advantages to using a system that can maintained, updated, or expanded by a number of different vendors.

For the second issue regarding satellite-based location systems, such systems are well-known and have many advantages. Specifically, some current traffic control systems use satellite positioning data to provide positioning information for a vehicle's VCU, and such satellite positioning data/information is often relatively reliable and accurate. The satellite-based positioning information may be used by the traffic control system to determine a vehicle within the traffic grid's location, as well as the vehicle's predicted travel path and timing. This information may be used to provide a priority hierarchy for the traffic system. However, satellite-based location systems can suffer from issues in areas with substantial tall obstructions to the satellite signal. Sadly, may urban areas where traffic control systems are more important have this characteristic.

Many ETA-based systems work well. Such systems are typically able to consider both the priority of some vehicles and the preferred schedules of other vehicles within the traffic grid. Accordingly, ETA-based systems are able to assist a variety of travelers in a traffic system navigate efficiently through a variety of different situations. For example, ETA-based traffic control systems are typically capable of routing an emergency vehicle to its destination in the fastest manner possible. The same system may be able to adjust the traffic signals within the traffic grid to keep its mass transit vehicles on schedule around rush hour. Knowing the position of the vehicles within the system, or at least some of those vehicles, along with each vehicle's direction of travel and speed, the traffic control system can adjust the traffic signals throughout the traffic control system to meet the needs and preferences of those who control the system itself. Accordingly, relatively precise location, speed, and direction information is of near paramount importance to ETA-based traffic control systems.

Unfortunately, satellite-based positioning systems may falter in a number of situations, in particular, by losing the ability to provide location data. Such a loss for even a short amount of time may cause significant issues for the relevant traffic control system. For example, an ETA-based traffic control system may lose positioning, speed, or direction information for a given vehicle when access to the sky is obstructed around that vehicle within the traffic grid. This obstruction routinely occurs when a vehicle is near or within buildings, underground, or in proximity to terrain having significant height. As a result, the traffic control system may lose track of the vehicle, which may hinder the system's ability to properly predict the vehicle's future movements, thereby rendering any attempts at keeping the vehicle on a schedule impossible. Accordingly, systems that rely on satellite positioning data may have significant performance problems when operating within an urban jungle, mountainous territory, underground, or in other locations with similar obstructions. Further, while satellite-based traffic control systems are generally very effective, they can completely fail in some situations. These problems may be exacerbated by such failures occurring repeatedly in certain locations, especially in locations that are perpetually obstructed from the reach of satellite positioning signals, such as in a tunnel, valley, or areas close to a large geological or structural features.

A number of alternatives to satellite-based positioning have been attempted. For example, some traffic systems have attempted to take advantage of dead reckoning positioning systems to provide positional data for a traffic control system. Further, other traffic systems have attempted to use line-of-sight positioning and similar radio-frequency-based systems (such as a Bluetooth®-based systems) to provide the needed positioning data. Unfortunately, some of such traffic systems have not proven to be sufficiently accurate. Further, each of these systems tend to be cumbersome in practice, requiring too many resources to design, operate, and maintain. For example, dead reckoning systems typically require expensive equipment for every vehicle monitored, which equipment is difficult and expensive to setup and maintain. Further, without proper setup and maintenance, dead reckoning systems are nearly worthless due to inaccuracies.

Street-imagery-based systems exist which are used to determine location. Street-imagery systems typically use cameras on the monitored vehicle to take a number of digital images of the vehicle's surroundings. A computer system then analyses these images to recognize objects. Some systems may use this recognition process in conjunction with known maps of the location to recognize landmarks around the vehicle. The distance from those landmarks may then be determined, helping to place the vehicle within the context of the known map. In a sense, this is similar to how humans determine their location by determining their whereabouts with reference to the visible cues around them. Such systems are capable of determining a vehicle's location.

Street-imagery-based systems have not been previously used to control or influence street signaling behavior. Instead, these systems typically compare the images acquired by the system to known images from the local area, like images available from services like Google Street View. When an object within an acquired image may be found within the known area images, the system may determine a position of the camera (and vehicle) when the acquired image was acquired. This process may suffer from poor resolution, however, as the accuracy of such a position determination is dependent on the quality of object recognition and the ability to determine the distance from the camera is to the recognized object. One reason why these tasks may be difficult is that the vehicle is typically travelling on a street that does not contain any objects for recognition. Instead, the objects tend to be located adjacent to the streets. As a result, all images of objects for recognition will be at an angle from the direction of travel. This may obscure three-dimensional objects or otherwise add uncertainty into a location determination. Further, because the vehicle is moving in a direction that will not pass through the object, determining distance can be made more difficult due to the additional lateral distance that must be considered. This may result on a greater than acceptable margin of error for determining the position of the relevant vehicle.

Further, current video detection practices are static in nature and are unable to accommodate for the dynamic changes that occur constantly beside streets and other roadways. This is due primarily to the static nature of the known objects within the mapping system being used. These known objects are typically formed from images taken in the past, which images are stored for future comparisons. Known objects are used by the system because (1) their locations are relatively static; (2) they can be imaged and then recognized within the images by a computer; and (3) the related data can be stored for future use by the location system. However, one downside to this system is that the images of known objects stored within the systems are not instantly replaced when something in the real world changes. For example, if a statue in front of a building is used as a known object, the system's positioning information may be compromised if that statue is moved or relocated. Thus, the accuracy of such a system is somewhat dependent on how frequently the scenery around streets changes and how often the known images are updated. In some cases, outdated data may result in imprecise positioning data. In other cases, changes to the subject matter of the known images in the real world may result in previously-identifiable objects and locations no longer being identifiable.

Moreover, current street-imagery-based positioning systems tend to provide only a current location without direction or speed information as they are used as a backup for locating systems. The lack of this direction and speed information may prevent a priority signal system (e.g. an ETA traffic control system) from calculating accurate ETA information for whatever vehicle is missing this information. Thus, street-imagery-based positioning systems may be able to place a vehicle within a certain street within the traffic grid, but such systems tend to fail at accurately predicting when the vehicle will, for example, arrive at a traffic light on that known street. As a result, the traffic system may not be able to provide efficient control of the traffic signals within the grid that would be possible had there been available sufficient direction and speed information for the vehicle.

Thus, there is a need in the art of traffic flow management for a system that is capable of controlling and adjusting signal lights based on the movement and position of one or more tracked vehicles within a traffic grid, where the movement and position of the tracked vehicles may be determined from on-board camera data.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are methods and systems for modifying a traffic flow control systems wherein a vehicle's real-time location and estimated time of arrival (ETA) is utilized to modify the priority management cycles of multiple traffic lights in a traffic grid, and the vehicle's real-time location and ETA are determined, at least in part, via the use of video processing.

Described herein, among other things, is a system for determining a location of a vehicle within a traffic grid, the system comprising: a vehicle computer unit installed in a vehicle, the vehicle computer unit including a camera; a priority detector unit communicatively coupled to a signal light controller at an intersection within the traffic grid; and a wireless network connecting the vehicle computer unit with the priority detector unit; wherein the vehicle computer unit uses the camera to determine the vehicle's position by: imaging a unique landmark and determining the vehicle is on a road segment adjacent the intersection coupled to the signal light controller because of the unique landmark being imaged; imaging a known object within close vicinity of the intersection, the known object being one of a plurality of similar known objects which are present at a plurality of intersections, each of the known objects having a generally identical known size and shape and having a generally identical position relative to the intersection to which it is in close vicinity; calculating from the imaging of the known object, a distance from the known object based on an imaged size of the known object in the camera image; and determining from the distance the location of the vehicle on the road segment.

In an embodiment, the system further comprises determining the vehicle's velocity by evaluating a change in the imaged size of the known object over time.

In an embodiment, the system further comprises calculating the vehicle's estimated time of arrival at the intersection based on the position and the velocity of the vehicle.

In an embodiment of the system, the vehicle computer unit requests the priority detector unit modify a signal light at the intersection based on the vehicle's estimated time of arrival at the intersection.

In an embodiment, the system further comprises calculating the vehicle's estimated time of arrival at a location beyond the intersection based on the position and the velocity of the vehicle.

In an embodiment of the system, the vehicle computer unit requests the priority detector unit modify a signal light at the intersection based on the vehicle's estimated time of arrival at the location beyond the intersection.

In an embodiment, the system further comprises a remote traffic control center, wherein the remote traffic control center is communicatively attached to the wireless network; wherein the vehicle computer unit transmits information chosen from the group consisting of: the vehicle's position, direction, velocity, and estimated time of arrival at the location beyond the intersection to the remote traffic control center; wherein the remote traffic control center determines a plurality of signal light controllers within the traffic grid which need to be modified for vehicle to reach the location beyond the intersection at a specified time; and wherein the remote traffic control center sends a signal to one or more of the plurality of signal light controllers to request modification of an associated signal light.

In an embodiment of the system, the vehicle is a mass transit vehicle, the specified time is a scheduled time, and the location beyond the intersection is a service stop for picking up passengers of the mass transit vehicle.

In an embodiment of the system, the vehicle is an emergency vehicle, the specified time is as soon as possible, and the location beyond the intersection is a destination of the emergency vehicle.

In an embodiment of the system, after the signal light is modified, the velocity is recalculated to determine if the velocity has changed.

In an embodiment of the system, the vehicle is a mass transit vehicle.

In an embodiment of the system, the vehicle is an emergency vehicle.

In an embodiment of the system, the vehicle computer unit requests the priority detector unit modify a signal light at the intersection because the vehicle is the emergency vehicle.

In an embodiment of the system, the known object is a signal light for intersections.

In an embodiment of the system, the known object is a traffic sign.

In an embodiment of the system, the traffic sign is a stop sign.

In an embodiment of the system, the known object is a pole holding a signal light at intersections.

There is also described herein, in an embodiment, a method for determining a location of a vehicle within a traffic grid, the method comprising: providing a vehicle computer unit installed in a vehicle, the vehicle computer unit including a camera; providing a priority detector unit communicatively coupled to a signal light controller at an intersection within the traffic grid; and providing a wireless network connecting the vehicle computer unit with the priority detector unit; the vehicle computer unit using the camera to determine the vehicle's position by: imaging a unique landmark and determining the vehicle is on a road segment adjacent the intersection coupled to the signal light controller because of the unique landmark being imaged; imaging a known object within close vicinity of the intersection, the known object being one of a plurality of similar known objects which are present at a plurality of intersections, each of the known objects having a generally identical known size and shape and having a generally identical position relative to the intersection to which it is in close vicinity; calculating from the imaging of the known object, a distance from the known object based on an imaged size of the known object in the camera image; and determining from the distance the location of the vehicle on the road segment.

In an embodiment, the method further comprises determining the vehicle's velocity by evaluating a change in the imaged size of the known object over time.

In an embodiment, the method further comprises calculating the vehicle's estimated time of arrival at the intersection based on the position and the velocity of the vehicle.

### BRIEF DESCRIPTION OF THE DRAWINGS

FIG. 1 provides a perspective view of the disclosed ETA priority system from a street-view perspective in an embodiment in which the system has a centralized server.

FIG. 2 provides a plan view of a known object that is a typical stop sign.

FIG. 3 provides a plan view of a known object that is a typical traffic light signal head.

FIG. 4 provides a perspective view of a known object that is a typical stop sign over time as a vehicle moves within a traffic grid.

FIG. 5 provides a diagram of the hybrid fixed geographic detection method and time point detection method of the disclosed ETA priority system.

FIG. 6 provides a communication diagram of an embodiment of the disclosed ETA priority system.

FIG. 7 provides a diagram of an embodiment of the fixed geographic detection method of the ETA priority system.

FIG. 8 provides a diagram of an embodiment of the time-point detection method of the ETA priority system.

FIG. 9 provides a diagram of an embodiment of an ETA configuration interface output table.

FIG. 10 provides a depiction of different orientations of the EVP thresholds to intersection-approach zones.

FIG. 11 provides another block diagram of the components of the disclosed traffic light ETA priority system, particularly the vehicle components.

FIG. 12 provides a hypothetical example of how the disclosed system works in practice to modify the phases of the traffic lights within the grid in order to keep multiple mass transit vehicles on schedule.

### DETAILED DESCRIPTION OF THE PREFERRED EMBODIMENT(S)

This disclosure is intended to teach by way of example and not by way of limitation. As a preliminary matter, it should be noted that while the description of various embodiments of the disclosed system will discuss the movement of mass transit vehicles (such as, but not limited to, buses, light rail trains, and street cars) through signal lights, this in no way limits the application of the disclosed traffic control system to use in mass transit systems. Any vehicle that could benefit from the ETA traffic control system with video processing described herein is contemplated. For example, it is contemplated that the system could be applied to and utilized by commuter vehicles, unmanned or autonomous vehicles, taxis, first responders, emergency vehicles, snow plows, bicycles, waste management vehicles, and even pedestrians.

Notably, throughout this disclosure, the term “computer” will be used to describe hardware that implements functionality of various systems. The term “computer” is not intended to be limited to any type of computing device but is intended to be inclusive of all computational devices including, but not limited to, mobile-processors, processing devices or processors, personal computers, work stations, servers, clients, portable computers, and hand held computers. Further, each computer discussed herein is necessarily an abstraction of a single machine. It is known to those of ordinary skill in the art that the functionality of any single computer may be spread across a number of individual machines. Therefore, a computer, as used herein, can refer both to a single standalone machine, or to a number of integrated (e.g., networked) machines that work together to perform the actions. In this way, the functionality of the computer or mobile-processor (101) discussed below may be at a single computer, or may be a network whereby the functions are distributed. Further, generally any wireless methodology for transferring the location data created by the mobile-processor (101) (and/or the camera system (115), discussed below) to the other component parts of the system to which it is communicatively networked is contemplated. Thus, contemplated wireless technologies include, but are not limited to, telemetry control, radio frequency communication, microwave communication, GPS, and infrared short-range communication.

Another component of the mobile-processor (101), in certain embodiments, is a combination GPS/UHF antenna. In the embodiment with the combination antenna, the combo GPS/UHF antenna contains the antennas for both the transceiver and the GPS unit. Notably, however, this combo antenna is not required and in other embodiments two separate antennas can be utilized. Generally, the combo antenna or separate antennas will be mounted on the top of the priority vehicle, although this location is not determinative. Further, in certain embodiments, the antenna will be connected to the mobile-processor (101) by two coax cable connections (one for UHF and one for GPS), although any method for connecting the antenna(s) to the mobile-processor (101) (including both wired and wireless technologies) is contemplated.

In a broad sense, the traffic control system described herein combines video-processing-based (also referred to as camera-based herein) position navigation systems with secure radio communications to accurately report a vehicle's real-time location, direction, and speed, along with an estimated arrival times at a signal light, a series of signal lights within a traffic grid, a distant signal light (e.g., one that is not the immediate next light that will be encountered), or a target location (such as a scheduled stop location), while enabling signal controllers to accommodate priority requests from these vehicles, allowing for these vehicles to maintain a fixed schedule with minimal interruption to other grid traffic. The traffic control system disclosed herein may also allow for the display of maps of vehicle and intersection activity on centrally-located monitors or in a vehicle in real-time and for the creation of detailed logs and reports of traffic flow patterns and activity in real-time for monitoring personnel. Thus, the system may utilize video processing data, or a similar technology, and secure radio communication to enable transit vehicles to report location and activity data to traffic controllers and/or central locations in real time. Further, the system may enable dispatchers or other monitoring personnel at a centralized or secondary remote location to see the time/distance between equipped vehicles in the traffic grid. The system also may allow for the generation and sending of automatic or manual alerts to notify vehicle operators of changes in route status.

In many embodiments, the traffic control systems disclosed herein will not be limited to only video-processing-based position navigation systems, but instead, the video-processing-based position navigation systems will augment or supplement satellite-based positioning systems also utilized by the traffic control system. The use of a satellite-based positioning systems is neither a requirement nor a hinderance. Further, the traffic control systems disclosed herein will not be limited to only ETA traffic control systems, though many embodiments will include ETA determinations and control traffic based, at least in part, on ETA.

First, this Application will discuss embodiments of the ETA-based traffic control system to provide an overview. Second, the components of the ETA-based traffic control system that are related to the use of a camera to determine the location, speed, and direction of a vehicle within the traffic grid are described. Third, the additional components of the system are described to fill in the gaps. Fourth and finally, applications of the many embodiments of the ETA-based system will be discussed.

Specifically, the ETA-based system herein is capable of adjusting traffic signal lights within the traffic grid in order to best route certain vehicles to certain locations within a certain time window. Simultaneously, the ETA-based traffic control system is capable of adjusting in real time to prioritize other vehicles (such as emergency vehicles or even personal commuter vehicles) and allow those other vehicles to arrive at a certain location in a minimum amount of time. The traffic grid includes means for detecting if a vehicle is approaching an intersection, and the system is capable of utilizing the planned routes of at least some vehicles within the system, such as mass transit vehicles. The system is particularly interested in knowing the likely arrival times for vehicles at traffic lights within the system because the lights are typically what dictate throughput through the system, and therefore, how fast or slow a vehicle is able to move therethrough. In turn, the ETA of the vehicle at an intersection with a traffic signal light is highly dependent on the movement of that vehicle through the traffic grid, and accordingly, the system includes means for determining how the vehicles is moving through the traffic grid. Although GPS-based positing technology can be very useful for this determination, and many embodiment of the systems described herein include such technology, camera-based positioning is included in embodiments of the system disclosed herein.

The camera-based portions of the traffic control system described herein are generally structured as follows. In its basic form, the hardware components of the system include a camera for recognizing and using known and typical objects located in the area of intersections, storage equipment for storing vehicle-based-camera-captured images known and typical object data, processing equipment for processing the necessary information, traffic control infrastructure to control traffic lights, and a communications system to allow the subparts of the ETA traffic control system to intercommunicate. As will be described further herein, the basic hardware components of the system (generally a camera and a related mobile-processor, VCU, or other computing device) generally communicate wirelessly using secure frequency hopping spread spectrum radio. The vehicle-mounted hardware components, such as the camera, utilize video processing and/or other known satellite positioning technology, such as satellite-based positioning systems, to determine the precise real-time location of the vehicle.

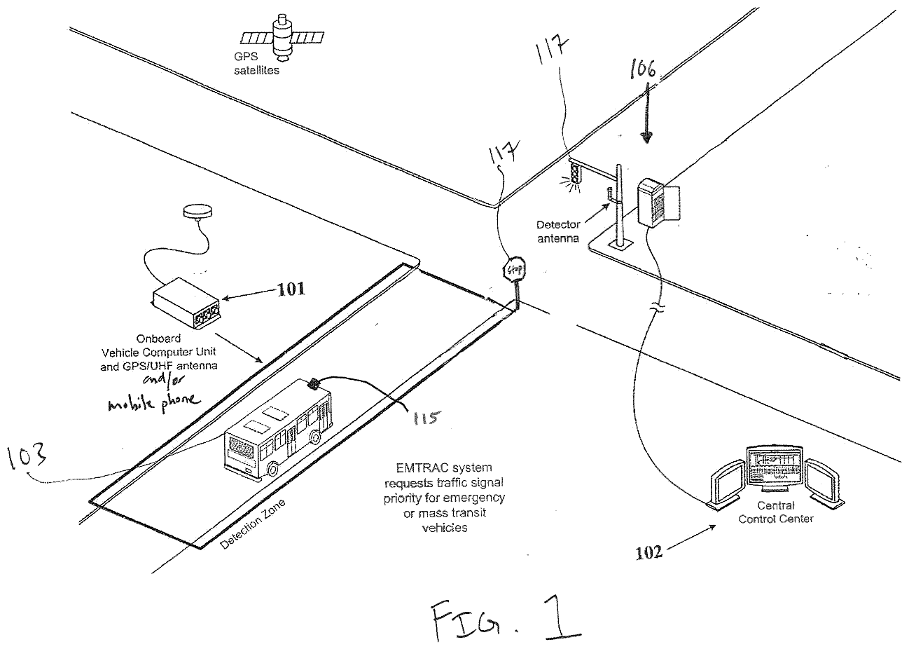

As demonstrated in a street-view of an embodiment of the system provided in FIG. 1, the mobile-processor (101) is carried by (or installed in) a monitored vehicle (103) in the traffic grid. As noted previously, contemplated monitored vehicles include, but are not limited to, mass transit vehicles (buses, trains, light rail, etc.), emergency vehicles (fire trucks, police cars, ambulances, snow plows, etc.), waste management vehicles, commuter vehicles, unmanned or autonomous vehicles, taxis, road maintenance vehicles, bicycles, and pedestrians. It should be understood that some embodiments of the system disclosed herein contemplate the installation of one or more VCUs in various vehicles traveling and operating in the traffic grid. In many other embodiments, the processing equipment (such as mobile-processor (101)) may be a mobile phone (or other computing device) instead of, or in addition to, a VCU.

Generally, the mobile-processor (101) serves several functions in the disclosed traffic control system. The mobile-processor (101) may determine the real-time location data for the vehicle in which it is installed. This data includes the vehicle's current location, direction of travel, and speed of travel. In certain embodiments, the mobile-processor (101) will also include a map of the traffic grid and the map and schedule of the mass transit vehicle (or other vehicle) in which it is installed, along with other mass transit vehicles in the grid. In these embodiments, the mobile-processor (101) may also have the capability of calculating and determining the vehicle's ETA at a future location and whether or not the vehicle is on schedule. The mobile-processor (101) also is capable of sending information regarding its speed, direction, location, and ETA to other components of the traffic system to which it is communicatively attached, including a remote traffic control center (102), a plurality of other mobile-processors or VCUs (101), and a plurality of priority detector units (105). In addition, the mobile-processor (101) is also capable of receiving information from these other components in the traffic control system. In sum, the mobile-processor (101) may function to determine the speed, direction, and location of its related vehicle in the overall traffic grid, transmit this information or utilize it to determine the vehicle's ETA to a predetermined point (and tangentially, whether it is on or off schedule), and transmit and receive information regarding the movement of the vehicle within the traffic grid to other component parts of the system.

One contemplated component part of the mobile-processor (101) is a camera system (115). Alternatively, the VCU or mobile-processor (101) may work in conjunction with a separate camera system (115). The camera system (115) will typically include one or more cameras having known focal lengths and other optical parameters. The camera system (115) will further include at least some processing power to run the image acquisition processes for the camera and at least some system to provide for communication with other portions of the ETA traffic control system. Further, the camera system (115) may include external computation devices to provide some of the camera system's (115) functionality. The camera system (115) may be used by the mobile-processor (101) to provide information relevant to the speed, direction, and location of the vehicle (103). Specifically, the camera system (115) may be used to provide a generalized location of the vehicle (103). The camera system (115) may be used to provide a specific location of the vehicle (103), typically by determining an estimated distance from an intersection or from a known object. The general and specific location determination processed will now be discussed in more detail.

For the generalized location determination, the mobile-processor (101) may use any or both of a number of systems, including a satellite-based system and a camera-based system.

For satellite-based positioning (also generally referred to as “GPS-based positioning” or just “GPS” because GPS is the most commonly used satellite-based positioning system in the United States), the system includes a receiver for a satellite positioning navigation system. Generally, any satellite positioning system known to one of ordinary skill in the art is contemplated including, but not limited to, the GPS, the Russian Global Navigation Satellite System (GLONASS), the Chinese Compass navigation system, and the European Union's Galileo positioning system. Further, any receiver technology known to those of skill in the art that is able to calculate its real-time position by precisely timing the signals sent by satellites, or by any other methodology known to those of ordinary skill in the art, is a contemplated receiver in the disclosed system. The installation of the receiver can be either permanent, by direct integration into the vehicle (103), or temporary, through a mobile receiver that can be taken into and removed from the vehicle, such as a mobile phone. Generally, the receiver of the mobile-processor (101) functions to determine the vehicle's (103) position, direction, and velocity in real-time at any given point during the vehicle's (103) travels. In alternative embodiments, it is contemplated that the mobile-processor (101) will determine the vehicle's (103) position, direction, and velocity through internal navigation systems known to those of ordinary skill in the art alternatively, or in addition to, satellite-based positioning systems. Contemplated internal navigation systems include, but are not limited to, gyroscopic instruments, wheel rotation devices, accelerometers, radio navigation systems, and camera-based systems.

For the camera-based systems, the vehicle-carried camera system (115) may capture images of the vehicle's (103) surroundings and use a lookup function to recognize known objects. Software may provide a recognition process, wherein the images obtained by the camera system (115) are analyzed by the software to determine if the images contain known objects, also referred to herein as landmarks. Any software systems that is capable of recognizing objects known to persons of ordinary skill in the art may be used. The objects or landmarks may be any object in real space that is: (1) visible in the camera system's (115) output; (2) recognizable by a related computer; and (3) has a known location in real space. Typically, these landmarks will be unique, though this is not strictly required. The related computer may be a portion of the camera system (115), or alternatively, a remote computer system (including both on-board computer systems, such as the mobile-processor (101), and computer systems external to the vehicle (103)). In either case, the output of the camera system (115), typically images of the surroundings of the vehicle (103), may be used by the related computer to search for known landmarks to roughly place the vehicle (103) within a portion of a traffic grid. Such a search will typically involve comparisons until the vehicle (103) may be placed. For any comparison, known objects must be saved in some form to some form of a database that is accessible to the related computer system that performs the comparison. Such storage may be a portion of the camera system (115), mobile-processor (101), or another system remote from the vehicle (103), such as a database hosted and available on the Internet.

Once it has been determined that the images from the camera system (115) have discovered the presence of known landmarks, the vehicle may be roughly placed within a road proximate to those known location of the known landmark. Typically, this will only be a rough estimate of location, being accurate enough to place a vehicle (103) within a specific block on a specific street.

For the specific location determination, the vehicle-carried camera system (115) may again use known objects (similar to the general location determination), but this time the known objects will be common objects within the vicinity of intersections. These objects, unlike those landmarked used for the general location determination, will not be placed specifically in any one location within the traffic grid, but instead, will occur at many, if not every, intersection within the traffic grid. These known objects near an intersection may then be used to determine the positioning, speed, direction of travel, and other aspects of the monitored vehicle (103) within the system. Specifically, the camera (115) may use a number of techniques to determine distance from a given, known object, as well as the vehicle's (103) speed and direction of travel relative to the object. In turn, this information may be used, along with some general location information, to determine a specific location of the vehicle (103) within the traffic grid, along with its speed and direction. Typically, another means will be used to determine a general location of the vehicle (103), for example, on which block of a given street the vehicle is currently travelling. This general location information may be supplied by any system, such as the general location determination system discussed above, or a dead reckoning system, a satellite-based position, any similar location determination system known to persons of ordinary skill in the art, or a combination of any of these.

To make the specific location determination, the mobile-processor (101) is typically used to make any required calculations, although other computers in the system, such as the central control center (102) or another networked computer, may be used. Further, as discussed, some form of generalized location process will typically first be used to place the vehicle (103) within a specific portion of the traffic grid, typically on a specific street segment between two intersections. This is because the process of using a common, known object to determine distance therefrom and a speed thereto merely places the vehicle (103) within the range of that specific object. However, as is needed to provide consistent results, the known object for the specific location determination is generally an object that is common throughout the traffic grid and available at most, if not every, intersection. The known object is preferably the same at every intersection so that the comparisons to determine distance, speed, and heading direction, discussed below, are accurate and quick to come by. Thus, these known, common objects are not useful for placing a vehicle within a specific area of a traffic grid alone. Instead, the data determined by the camera (115), at first, is only useful to place the vehicle at or near a specific location on a specific (and possibly unknown) street. The general location information is, therefore, useful to place the vehicle (103) on a specific street, and then the data from the camera (115) in the specific location determination may be used to determine a more precise location within that street segment. Further, multiple distance locations may be used to determine a speed and direction of travel for the vehicle (103) by considering the time between determinations and changes in the images taken by the camera system (115).

The calculation or determination step in the specific location determination may be accomplished using any means known by persons of ordinary skill in the art. Several specific processes that may be used will now be described, but the invention is not limited to these enumerated examples. Instead, any method known to a person of ordinary skill in the art may be used.

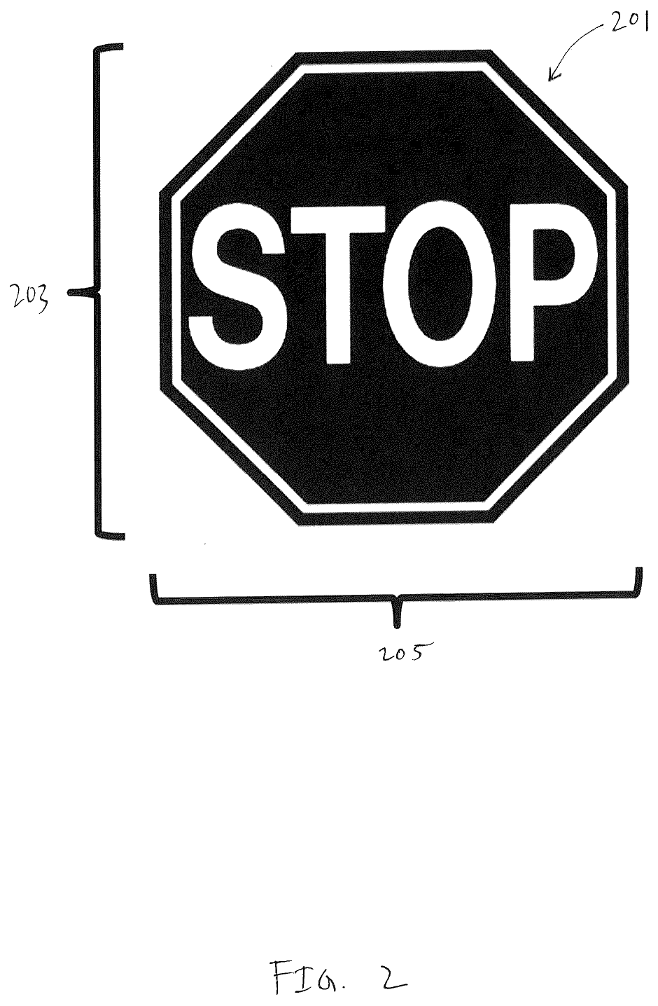

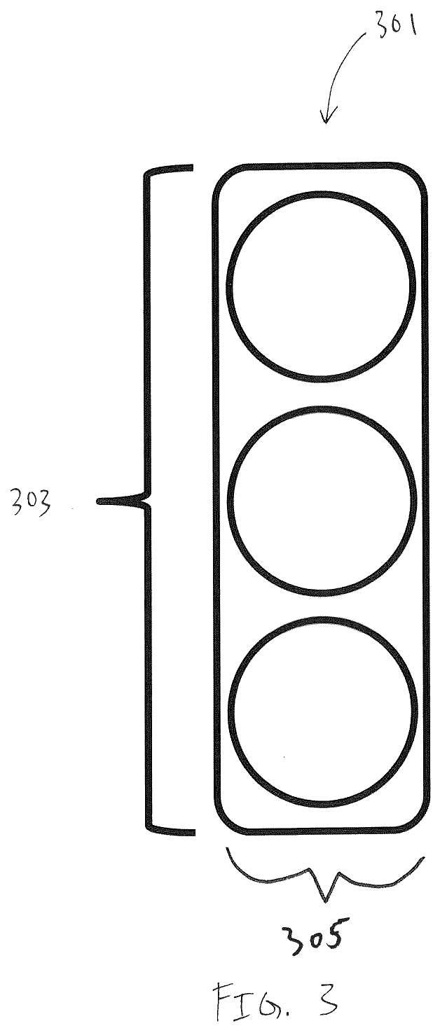

One exemplary process includes the use of a lookup table that is accessible to the camera system (115). During development or calibration of the camera system, the known objects, such as a stop sign (201) and a traffic light signal head (301) (shown in FIGS. 2 and 3) may be assigned values for the camera system (115). Images of either a stop sign (201) or a traffic light signal head (301) may then be captured by the camera (115) while the vehicle (103) is within the traffic grid. The height (203, 303) or width (205, 305) of the object may then be determined by the camera system (115). This determined value may then be compared to values found within the lookup table, which will deliver a known distance from the known object based on the inputted height/width value. This determination may use methods known to persons of ordinary skill in the art, including without limitation pixel counting, to determine the various heights of the known objects at different distances. For example, a stop sign (201) may have a height (203) of 10 pixels at a distance of 50 feet from the camera (115) and a height of 20 pixels at a distance of 25 feet from the camera (115). These values may be determined in advance of use of the camera system (115) by using the actual cameras (including the lenses used for the system) during a calibration or learning setup. This setup could be conducted in the traffic grid itself or set in advance by the manufacturer, the manager of the camera system (115), or any other entity. The setup process may populate a lookup table that correlates measured heights to known distances.

In some embodiments, the camera system (115) may be capable of compensating for the variances in perceived heights (203, 303) and widths (205, 305) of known objects being offset in the vertical or horizontal directions from the camera system (115) using geometric techniques known to persons of ordinary skill in the art.

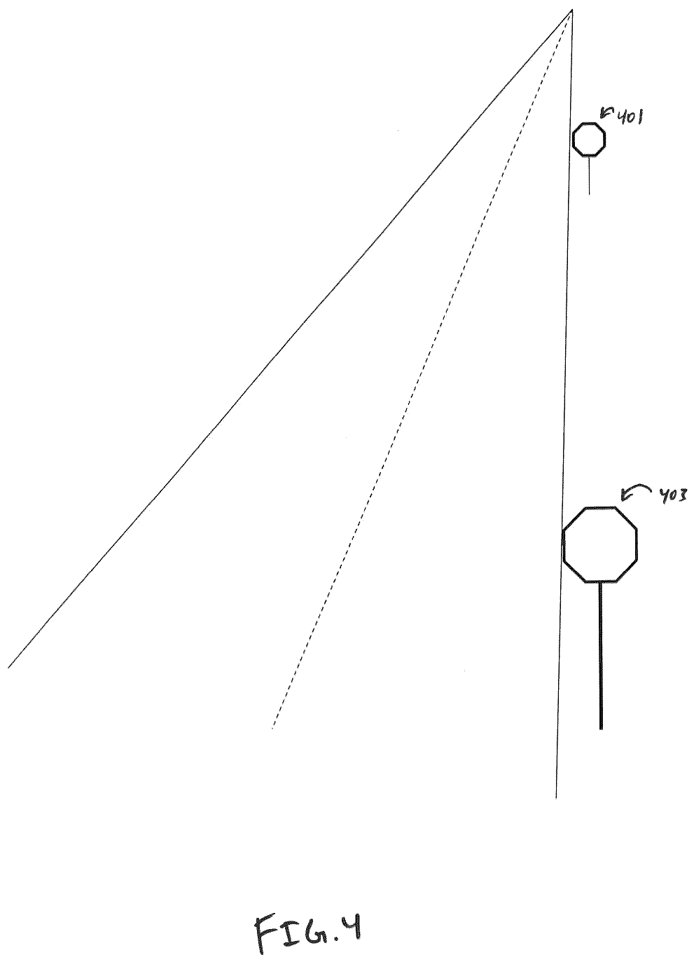

Further, as discussed above, multiple distance determinations may be used to determine a speed of the vehicle (103). As shown in FIG. 4, the apparent size of a single stop sign (401, 403) may change over time if the vehicle (103) is moving relative to the stop sign. In FIG. 4, the first image of a stop sign (401) is taken at time t1. After one second passes, the camera system (115) may take a second image of the stop sign (403) at time t2. Now that the stop sign (401, 403) is closer, the stop sign (403) appears to be larger than it (401) did at time t1. The distances from the vehicle (103) may be determined at each of times t1 and t2. The difference between these two distances, divided by the time between the two images (t2 minus t1, which is 1 second in this example), will net the speed of the vehicle. Further, because the stop sign (401, 403) has enlarged over time, the camera system (115) also knowns that the vehicle (103) is traveling towards the stop sign (401, 403) within the traffic grid. In the above ways, the location, speed, and heading of a vehicle (103) may be precisely and repeatedly calculated.

Accordingly, the mobile-processor (101) may use the camera system (115) to determine a specific location of a vehicle (103), especially when a GPS-based system is unavailable.

In addition to a receiver and a camera system (115), the mobile-processor (101) also generally contains a computer that is capable of transferring the location data, coordinates, and speed of the vehicle (or other information) to the other networked components of the system. Another contemplated component of the mobile-processor (101) is a radio transceiver. Generally, any device for the transmission and receiving of radio signals including but not limited to the FHSS and/or FH-CDMA methods of transmitting radio signals is contemplated.

Generally the mobile-processor (101) will be programmed with preferred vehicle response settings, applicable intersections, the vehicle's schedule, a map of the overall grid, and vehicle detection zones for applicable signal lights in the grid. In certain embodiments, it is contemplated that the mobile-processor (101) will include a user interface known to those of ordinary skill in the art. Among other things, this user interface will provide a view of the map of the overall grid, vehicle detection zones for applicable signal lights in the grid, and the location of other mobile-processor-equipped vehicles in the grid.

In one embodiment, the mobile-processor (101) will be powered directly by the vehicle battery. For example, in one contemplated embodiment, the mobile-processor (101) will be powered directly by 12 VDC from the vehicle battery. In other embodiments, the mobile-processor (101) will be powered by a portable power unit known to those of skill in the art including, but not limited to, batteries and solar panels. This is true in embodiment wherein the mobile-processor (101) is a mobile phone.

Now, additional components of the ETA-based system will be discussed. A additional component of the traffic control system described herein is a plurality of priority detector units (105). The priority detector units (105) of the disclosed traffic control system generally function to modify and control the associated signal light based upon the velocity (speed with heading), location, coordinates, ETA, and priority signals of mobile-processor-equipped vehicles in the traffic grid. Generally, the priority detector units (105) receive ETA notifications from mobile-processor-equipped vehicles in the grid and precondition their timing signals to the signal controller (106) based upon a mobile-processor-equipped vehicle's arrival at the intersection. Receipt of advanced signals from mobile-processor-equipped vehicles in the grid helps the controller gradually modify the timings of the signal light to reduce the impact on the intersection while also enabling the intersection to maintain coordination with other intersections along a corridor.

The priority detector units (105) will generally be located at or near particular traffic light signals and signal controllers (106) in the area controlled by the disclosed system. In typical embodiments, each priority detector unit (105) will be co-located within a particular signal light controller (105) cabinet. However, this location is not determinative. It is contemplated that the priority detector unit (105) may be located at any proximity near a particular signal light that allows the priority detector unit (105) to receive applicable signals from the remote traffic control center (102), other priority detector units (105), and/or the mobile-processors (101) and allows the priority detector (105) to send calls to the signal controller (106) to modify the phases of the respective signal light that it monitors.

The priority detector unit (105) will generally send a variety of outputs using the standard North, South, East, and West discreet outputs for a signal controller (106) based on information regarding a vehicle's geographical zone position, velocity, and ETA, among other logistical information received from the mobile-processors (101), remote traffic control system (102), and/or other control centers.

In one embodiment, the priority detector unit (105) will control multiple geographical or virtual zones for a single light. For example, it may have a different zone pertaining to a light rail track, an in-street bus line, and a standard road signal even though all the various zones partially or totally overlap in a geographic sense. Generally, this standard output sent by the priority detector unit (105) (e.g., turn the North-bound light green) will be held until the vehicle leaves the detection zone. The priority detector units (105), in certain embodiments, generally will use auxiliary outputs (e.g., AUX1, AUX2, and AUX3) to communicate this standard output to the signal controller (106). However, any mode known to those of ordinary skill in the art for communicating the output signals from the priority detector unit (105) to the signal controller (106) is contemplated in this application. Further, in certain embodiments, a binary ETA status is applied to these three auxiliary outputs to designate the current ETA status of an approaching mobile-processor-equipped vehicle. In certain embodiments, some status outputs will be held for one second, whereas other status updates will be held until the mobile-processor-equipped vehicle checks out of the geographic detection zone.

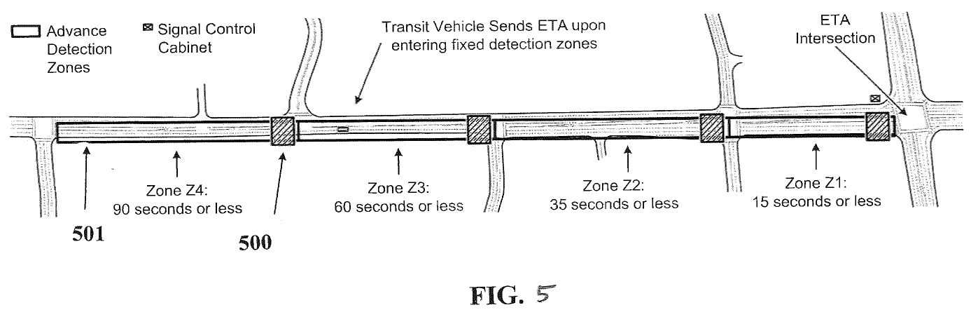

Generally, the priority detector unit (105) of the ETA traffic control system is capable of sending a variety of output calls to the signal controller (106) with which it is associated. Examples of contemplated calls include, but are not limited to, cancel calls, checkout calls, emergency vehicle priority (EVP) calls, transit signal priority (TSP) (0-3) calls and EVP threshold calls. Each of these calls controls or in some way modifies the functioning and operation of the signal controller (106) based upon the speed, location, ETA, or other data received from mobile-processor-equipped vehicles in the traffic grid. Generally a “cancel” call is a call output issued when the priority detector unit (105) is notified by the mobile-processor (101) that the vehicle has gone into standby mode. For example, mass transit vehicles may be configured to enter standby mode when a stop is requested or when the doors open. In such situation, the vehicle has no need of any priority as it is no longer traveling towards the intersection. A “checkout” call is generally an output issued when the vehicle leaves the intersection approach zone. It is at this point that the vehicle has generally either arrived at the intersection or turned off the approach and therefore would no longer be affected by the relevant signal light(s). EVP calls are output calls issued when an equipped emergency vehicle enters the detection zone. The TSP (0-3) calls are the outputs issued at the intervals defined in the threshold TSP fields. The threshold TSP fields are various advanced detection zones preceding the signal light (such as zones Z4-Z1 in FIG. 5) at which a mobile-processor-equipped vehicle transmits its ETA to an applicable priority detector or other networked component of the system. Finally, the EVP threshold is the maximum number of seconds at which EVP requests should be sent to the signal controller (106). For an example, a “200” in this field would not allow EVP calls to be sent by the priority detector unit (105) to the signal controller (106) until the vehicle is no more than 200 seconds from the intersection. This keeps a light from changing too early to accommodate an emergency vehicle and being overly disruptive of traffic and possibly resulting in other driver's ignoring their red light in frustration.

Generally, the mobile-processors (101) and priority detector units (105) of the ETA traffic control system will be connected by a wireless technology known to those of skill in the art that allows for the free transfer of data and information between each of these components through a traffic control network (104).

In one embodiment of the ETA traffic control system, the actual control of the intersection continues to be performed by the particular signal light controllers (106) located at each respective traffic light in the controlled system. The ETA traffic control system simply offers new inputs to the signal light controllers (106) regarding the timing and phase changes of each respective traffic signal light in the system in order to accommodate mobile-processor-equipped vehicles and attempt to keep them on schedule.

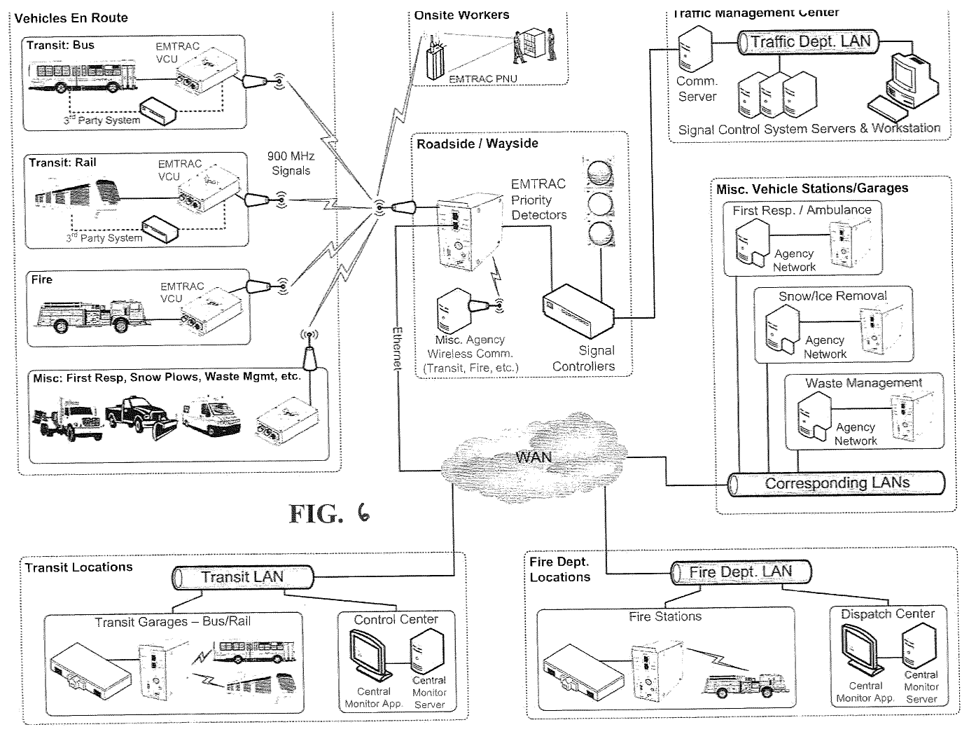

In an embodiment of the ETA traffic control system in which a centralized control server is utilized, another component of the traffic control system is the remote traffic control center (102). Generally, the remote traffic control center (102) is a central server; i.e. a computer or series of computers that links other computers or electronic devices together. Any known combination or orientation of server hardware and server operating systems known to those of skill in the art for servers is contemplated as the remote traffic control center (102). As detailed more fully later in this application, in the centralized server embodiment of the system the remote traffic control center (102) is linked to the mobile-processors (101) and the priority detector units (105) of the system by a wireless network that allows for the free transmission of information and data therebetween allowing centralized control of a number of signals. Thus, the system of this embodiment can control signals that may be unrelated to the path taken by the vehicle while still accommodating the vehicle's passage. In other embodiments of the ETA traffic control system in which a centralized control server is utilized, the system will consist of a remote traffic control center (102) and possibly other control centers. It is contemplated that these other control centers would be located at control or dispatch centers associated with the mobile-processor-equipped vehicles operating in the traffic grid. Such locations include, but are not limited to, transit operation locations, fire departments, police stations, first responder/ambulance stations, snow/ice removal vehicle stations, and waste removal management stations. An embodiment of the ETA traffic control system with a remote traffic control center (102) and a possibly other control centers connected to the rest of the system by a network (104) is provided in FIG. 6.

The ETA traffic control system disclosed herein is generally capable of reporting a vehicle's real-time location and ETA to a given location using fixed geographic detection, variable time-point-based detection, or a combination of both. Further, in additional embodiments, the system can be structured and customized to allow for timing changes or pre-conditions that must be satisfied before signal priority is granted to a vehicle.

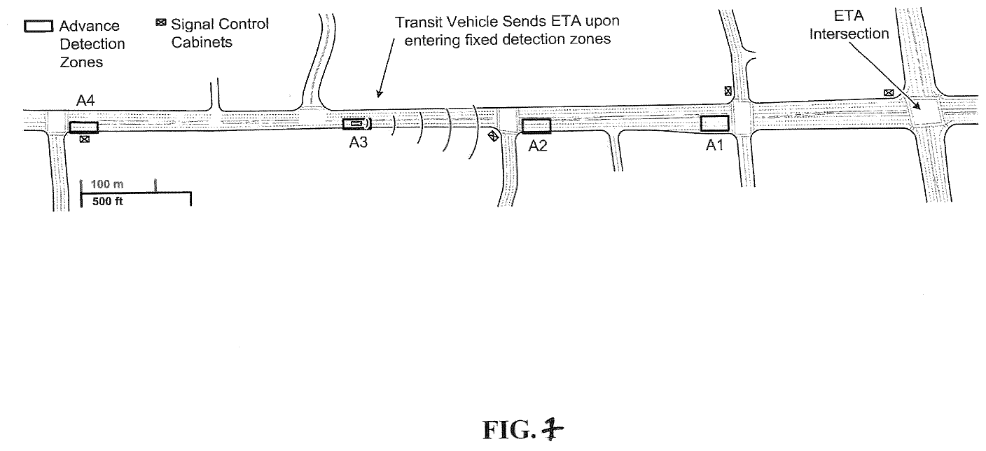

In a fixed geographic detection method, the ETA traffic control system utilizes a positioning system (such as a satellite positioning navigation system, a camera-based system, or any other system known to persons of ordinary skill in the art) to create virtual “loops” that are set up at specific defined points along a vehicle's route. A series of these virtual loops or advanced detection zones leading to a particular ETA intersection are depicted in FIG. 7. As vehicles equipped with a mobile-processor (101) enter and pass through these zones (labeled A4-A1 in FIG. 1), they place ETA calls to the appropriate priority detector units (105) (or central server (102) in the centralized embodiment). For example, in the embodiment depicted in FIG. 7, the mobile-processor (101) would place ETA calls to the priority detector unit (105) associated with the ETA intersection when the vehicle entered each of the fixed detection zones preceding the ETA intersection; i.e., advanced detection zones A4, A3, A2 and A1. Thus, in one embodiment, the mobile-processor-equipped vehicle would transmit a signal of its ETA (or simply its coordinates) to a given intersection to the priority detector unit (105) associated with that intersection upon reaching detection zones A4, A3, A2, and A1. The priority detector unit (105) will then send an output signal to the signal controller (106) for the ETA intersection as necessary to modify the light to keep the mobile-processor-equipped vehicle on schedule. In embodiments in which the system is centralized, the mobile-processor-equipped vehicle will send a signal of its ETA (or simply its coordinates) upon hitting the detection zones A4, A3, A2, and Al to the priority detector unit (105) for the intersection and/or the remote traffic control center (102). Notably, in this method, the detection zone locations and configurations can be edited on the fly by administration of the system—i.e., the location of A4, A3, A2, and A1 can be modified by a user interfacing with the system at either a mobile-processor (101) or a central (102) or other control center. Basically, in this method, the location of the vehicle is fixed at transmission, and the transmission records to the expected time to arrival are based on speed and related factors of the vehicle.

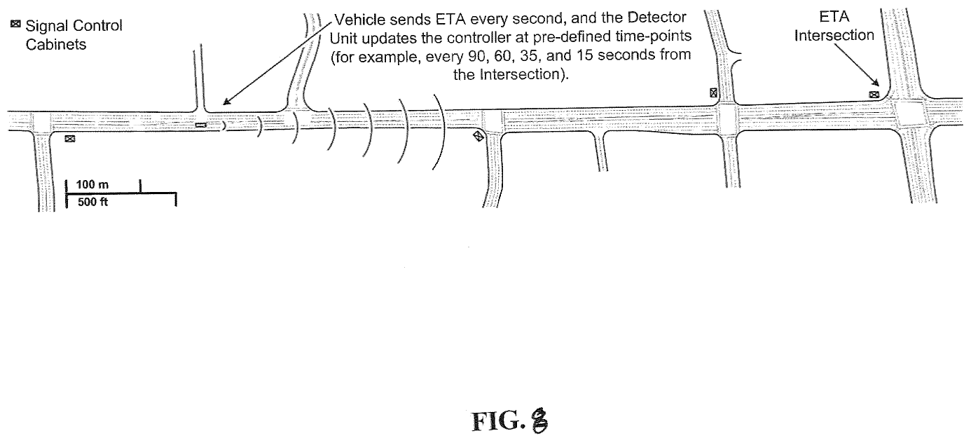

In the time-point detection method, a calculated ETA is used to determine when advance communications and priority requests are sent. In this method, the mobile-processor (101) located within the priority vehicle calculates the vehicle's time-distance from a selected intersection (or other pre-defined location in the grid) and transmits that amount (or simply its coordinates) to the appropriate priority detector unit (105) (or central server (102) in the centralized embodiment) along with its position. In one embodiment, the transmission from the mobile-processor (101) to the priority detector unit (105) occurs once per second, however, any time/signal allocation is contemplated. FIG. 8 provides a depiction of the time-point detection method. As demonstrated in FIG. 8, the mobile-processor-equipped vehicle will send its ETA (or simply its coordinates) to the ETA intersection priority detector (105) (or the remote traffic control center (102) in the centralized embodiment) every second. The priority detector unit (105) will then send an updating output of the vehicle's ETA to the signal controller (106) at pre-defined intervals (such as every 90, 60, 35, and 15 seconds from the vehicle's ETA).

In the hybrid fixed geographic/time point detection method, both a mass transit vehicle's calculated ETA and the mass transit vehicle's current location within an approach zone of a particular intersection is used to determine when advanced communications and priority requests are sent. FIG. 5 offers a depiction of this hybrid method. As demonstrated in FIG. 5, in this method the approach zone leading up to a selected intersection (or pre-defined location within the traffic grid) is divided into a series of one or more fixed geographic zones. For example, in the approach zone depicted in FIG. 5, the approach zone is divided into four (4) zones (501); i.e., zones Z1-Z4. At the end of each of the designated approach zones is a check out-zone (500). Similar to the time-point detection method, in this method the mobile-processor (101) located within the priority vehicle calculates the vehicle's time-distance from a selected intersection (or pre-defined location within the traffic grid). However, in this embodiment depicted in FIG. 5, a vehicle within the first zone (501), the Z4 90-second zone, would send a 90-second ETA to the appropriate priority detector unit (105) (or central server (102) in the centralized embodiment) only if the mobile-processor (101) calculates a 90-second ETA while the vehicle is within the Z4 zone (501). If the vehicle does not achieve a 90-second ETA within Z4, it will transmit its actual calculated ETA call when it reaches the check-out zone (500) at the end of the zone (501). The same process would follow for each successive zone (but each successive zone would be assigned a different ETA time value, such as 60 seconds, 35 seconds, or 15 seconds, as depicted in FIG. 5). Stated differently, a mobile-processor (101) equipped vehicle will transmit its calculated ETA to the appropriate priority detector unit (105) (or central server (102) in the centralized embodiment) in each respective zone (501) if the assigned ETA value for that zone (501) is achieved within that zone (501) and, regardless of whether the assigned ETA value for that zone is achieved within that zone, when the mobile-processor (101) equipped vehicle reaches the check-out zone (500) within the zone (501). Thus, in this method, ETA signals are sent when a fixed geographic zone is reached (i.e., when a mobile-processor (101) equipped vehicle reaches a check-out zone (500)) and when a certain ETA time point is reached within a certain zone (501) in the approach path. Notably, it should be understood that the orientation and number of zones (501), as well as the ETA time values proscribed to the zones (501) represented in FIG. 5, are not determinative. The assigned ETA times and the orientation and number of the zones (501) is only exemplary, and it should be understood that any time and zone orientation can be specified by a user of the system described herein.

Further, it should be understood that the time-point detection method, the fixed geographic detection method, and the hybrid method are not exclusive of each other. Thus, it is contemplated that the ETA system described herein may simultaneously utilize multiple detection methods, or different components of each of these detection methods, in its control of the traffic grid.

In one embodiment, the ETA transmitted in these methods is calculated and determined in the vehicle, not at the priority detector unit (105) or the centralized server (102). In such an embodiment, the vehicle's time-distance, or ETA, is determined by the mobile-processor (101) by utilization of an ETA calculation algorithm that takes into account the vehicle's continually changing speed and distance from the intersection. The determinations of the speed and distance are, in turn, determined by the camera-based, satellite-based, or other positioning system, as discussed above. Upon receiving the ETA time-point data, the priority detector unit (105) then updates the intersection signal controller (106) at user defined timed-ETA or position points. The types of ETA calls that can be output by the priority detector unit (105) include “Cancel” calls (for cases where the approaching vehicle turns off the approach street) and “Checkout calls” (when the vehicle reaches the intersection and ETA is no longer applicable). Because these methods consider vehicle speed in their calculations (i.e., the vehicle's ETA is determined by utilization of an ETA calculation algorithm that takes into account the vehicle's continually changing speed, both instantly and potentially within a period of history), they can be advantageous in heavy traffic areas with high variability in traffic flows throughout the day. Notably, in other embodiments of the system, it is contemplated that a vehicle's ETA will be calculated and determined at the remote traffic control center (102) or the priority detector unit (105) via utilization of a similar ETA calculation algorithm.

In sum, by utilizing a vehicle's future ETA at a pre-defined point as the trigger-point for determining the phases of the signal lights at applicable intersections within the grid, the system disclosed herein may allow for the adjustment of various signal lights along the path to the ETA point in an efficient manner that keeps the priority vehicle on-time to its end destination with minimal disruption to the traffic grid as a whole. In contrast to the priority systems of the prior art, the disclosed system is not limited to only granting priority to the vehicle at the next light that it is approaching without any correlation to the other signal lights along its path on the grid. Thus, unlike the detection zone systems of the prior art that track a vehicle's ETA from a fixed location, the system disclosed herein reacts to changes in on-street congestion and vehicle approach speeds in real-time. As the traffic volumes fluctuate, so do the positions of ETA time-points. Further, upon receiving the vehicle ETA notifications, the traffic controller (106) preconditions its internal timings in preparation of a mobile-processor-equipped vehicle's arrival at the intersection. The advanced time-points help the signal controller (106) gradually modify the timings to reduce the impact on the intersection while also enabling the intersection to maintain coordination with other intersections along a corridor.

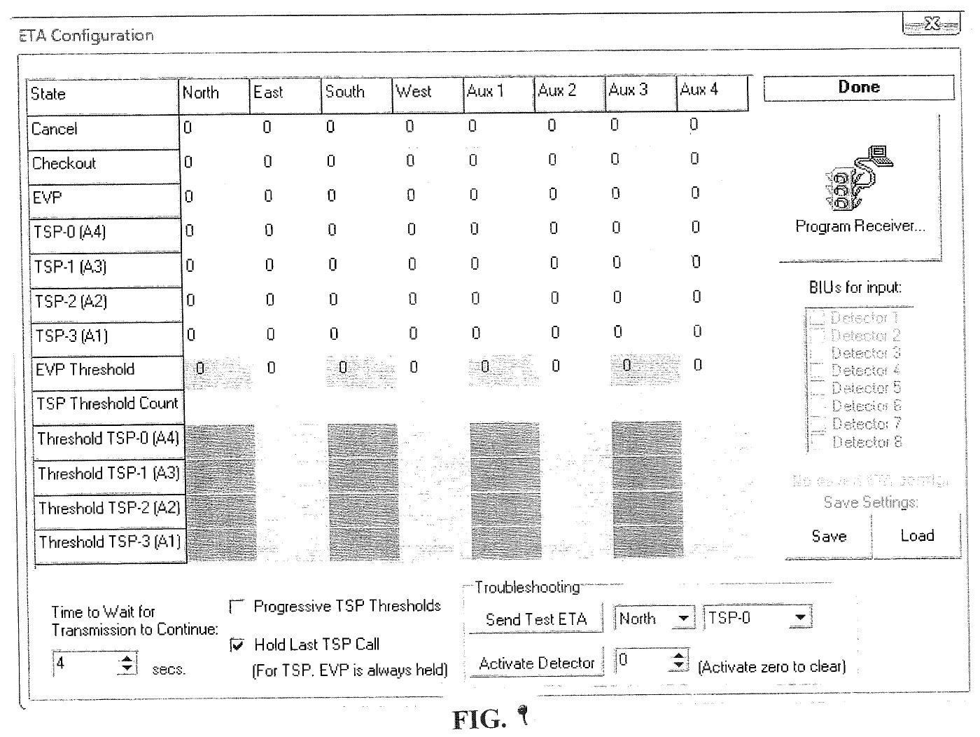

Generally, the ETA time-points are user defined and can be set up to report at any number of time intervals or can be set using a per-intersection approach in a specifically defined orientation. In one embodiment in which the time-points are user defined, an ETA configuration interface window will be utilized to allow a user to set the time points in which ETA values are to be transmitted to the signal controller (106). An embodiment of this ETA configuration interface output table is depicted in FIG. 9. In the depicted output table of FIG. 9, the values in the top seven rows correspond to the appropriate priority detector unit (105) input channels on the signal controller (106). The remaining rows specify the number of seconds required to carry out the given action or status.

As noted previously, there are a number of different contemplated output calls from the priority detector unit (105) to the signal controller (106). As depicted in FIG. 3, these calls include the cancel call, the checkout call, the “EVP” call, the TSP (0-3) call, and the EVP Threshold call. Generally, the “Cancel” call is the ETA output given when the priority detector unit (105) is notified by the mobile-processor (101) that the vehicle (103) has gone into standby mode. For example, mass transit vehicles may be configured to enter standby mode when a stop is requested or when the doors open. Generally, the parameters that put a vehicle (103) in standby mode are defined in the mobile-processor (101) and may need to be customized based on vehicle connections.

The “Checkout” call is the ETA output given when the vehicle (103) leaves the intersection-approach zone. The intersection-approach zone is the defined detection zone preceding a given signal light. Generally, at this point, the vehicle has either “arrived” at the target point (such as the stop or intersection) or has turned off the approach path to the point. In this situation, the vehicle is no longer regulated by the particular priority system to that target ETA point (although it may now be on a different system).

The “EVP” ETA output is generally the output call issued when an equipped emergency vehicle or other vehicle that requires an immediate signal light change has entered the intersection-approach zone. In EVP scenarios, the ETA call is generally sent and held until the vehicle checks out of the approach. This allows an emergency vehicle to be given a different priority than a mass transit or other vehicle while still using the same system of vehicle detection in order to simplify signal transmission and better integrate different options.

The TSP (0-3) calls are generally the ETA output calls at the intervals defined in the Threshold TSP fields in the fixed-detection zone model. Typically, TSP-0 is the first call sent, followed in order by the remaining calls. Although this order may be reversed or otherwise altered in accordance with controller settings.

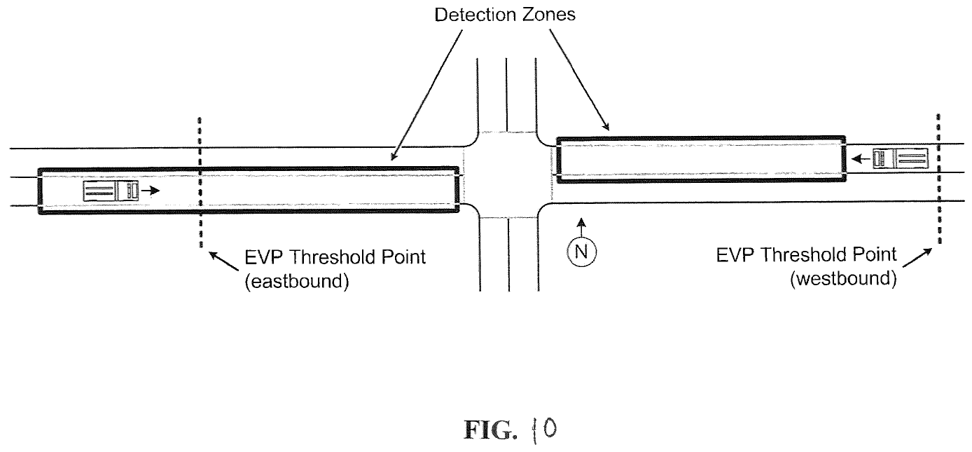

The EVP Threshold in the output chart represents the maximum number of seconds at which EVP requests should be sent to the signal controller (106). For example, a “200” in this field would not allow EVP calls to be sent to the signal controller (106) until the vehicle is no more than 200 seconds from the intersection. In one embodiment, it is contemplated that the EVP threshold will be located after the beginning of the intersection-approach zone, as depicted by the eastbound threshold point of FIG. 10. That is, the detection zone is relevant for only the immediately approaching signal. Under these circumstances, the vehicle (103) would not report its ETA until it passed the EVP threshold within the detection zone. In another embodiment, it is contemplated that the EVP threshold would begin well before the approach zone, so the vehicle (103) would report ETA as soon as it enters the approach zone to allow for an interface with a number of signals and the pre-established target destination. This orientation of the EVP threshold is depicted in the westbound threshold point of FIG. 10.

The TSP Threshold is the total number of time points at which ETA will be output to the signal controller (106) in the time-point detection method. For example, a “4” in this field enables the priority detector unit (105) to update vehicle ETA status at four time points, for example at 90, 60, 30, and 15 seconds from the intersection. Finally, the Threshold TSP (0-3) in the output chart represents the number of seconds from the intersection at which ETA status is output to the signal controller (106). Typically, TSP-0 is the first call sent, followed in order by the remaining calls, TSP-1, TSP-2, and TSP-3.

In addition to the values entered into the ETA configuration output chart, there are a number of additional potential fields and user input positions in some embodiments of the ETA configuration interface that allow for a user to offer input and instructions into the system. For example, the Time To Wait for Transmission Continue field defines the amount of time the priority detector unit (105) waits before dropping the vehicle's ETA status. Here, if an equipped vehicle turns off the approach street after its first ETA point has been reported, the priority detector unit (105) will drop the vehicle status after four seconds. In most cases, it is not necessary for a user to change or manipulate this field, as it is a system for simply clearing unnecessary priority requests.

Another notable field is the Progressive TSP Thresholds field. When this box is selected, ETA time-points that have already been called are not allowed to be called again. For example, if a 30-second ETA has already been called and traffic conditions slow down to the point where it will take over 30 seconds to arrive, the 30-second ETA will not be called again.

The Hold Last TSP Call Field is a field that, when selected, holds the last ETA call (e.g., the Threshold TSP-3 call) until the vehicle leaves the intersection approach. This operates similar to the way in which EVP calls are held as it relates to the final approach to the final signal prior to the destination point. The Send Test ETA controls enable a user to send ETA test calls by vehicle direction and specific call type. These calls are generally sent directly from the priority detector (105).

The Activate Detector field controls enable a user to send a specific detector value for specific controller input channels. For example, if the value used to send TSP-0 calls for a northbound approach is 36, then 36 will be inputted into this field and “activate detector” will be pressed to send that last ETA call. These calls are sent directly from the priority detector unit (105). The Bus Interface Units for input list displays the current status of the Bus Interface Unit detectors (for the connected priority detector units (105)) that have been set up as inputs. Finally, the program receiver field assigns the entered ETA values to the connected priority detector unit (105).

Another signal option for the disclosed system in certain embodiments is a system of conditional transit signal priority. These conditional transit signal priority signals are generally based on the amount of time a mobile-processor-equipped vehicle is behind schedule. To achieve conditional TSP, the system is generally configured to request signal priority only when activated through a connection to the onboard schedule-adherence system. For example, when a mobile-processor-equipped vehicle lags behind schedule by a set amount of time, the schedule-adherence system enables the components of the system to request signal priority for upcoming intersection. If the mobile-processor-equipped vehicle is on schedule, signal priority is not requested, allowing the buses to better maintain headway. Generally, in a conditional priority system, certain user-established pre-conditions must be met before the priority detector unit (105) will send a signal priority request to the signal controller (106). These conditions can be set and modified by the user and controller of the system. Examples of some of the pre-conditions that can be set by a user include, but are not limited to, not sending a signal priority request if: another mobile-processor-equipped vehicle has not requested priority within a specified time frame (for example, eight minutes); the mobile-processor-equipped vehicle doors are closed (i.e., the bus is not at a stop with open doors); or an exit request has not been made for the next stop.

Yet another signal option for the system described herein is automatic vehicle location. This option of the system helps to mitigate the problem of bunching along mass transit routes. To prevent this problematic occurrence in the automatic vehicle location (AVL) mode, both the drivers of the at-risk “bunched” vehicles and a supervisor of the vehicles can be notified and alerted of the potential problem. Then automated (or supervisor-actuated) commands can be issued for the lead vehicle (such as, for example, a bus) to operate in express or skip-stop (where a typically scheduled stop is not made to allow the vehicle to advance more quickly) mode until an acceptable gap is reestablished. For example, the lead mass transit vehicle can be granted transit signal priority (to help keep it on schedule) while not granting priority for the trailing bus (to maintain the desired headway amount between the two vehicles). Thus, in this mode, the system only sends TSP requests to a signal controller (106) when pre-defined bunching conditions (such as a specific amount of time behind schedule) have been met. In this mode, the acceptable schedule variances and headway amounts can be determined by the transit agency and programed into the system at the mobile-processor (101), the remote control center (102), or another computer system. If further action is required to maintain an identified minimum headway, the central monitoring system at the remote control center (102) may recognize the reduced headway amount and notify personnel at central locations who can respond accordingly (for example, by authorizing skip-stop mode for the leading mass-transit vehicle).

When used in conjunction with TSP, this mode is capable of protecting transfers and supporting schedule adherence for mass transit vehicles in the event of the non-recurring obstacles to normal transit operations which often lead to bunching, such as road construction, traffic accidents, weather, double-parked vehicles, special-event travel demand, wheelchair lift use, and so forth. Thus, in sum, the system in this mode allows for: transit vehicles to request signal priority when defined headway limits are reached, making schedule adherence easier to achieve; negative trends (such as reduced headway amounts) to be recognized by the system, allowing for automatic notifications to be set up to alert dispatchers when predefined trend rates or thresholds are reached; allowing vehicles and dispatchers to perform multiple actions (such as enabling TSP or enacting skip-stop modes) to reestablish headway amounts; and allowing for monitoring personnel to view headway amounts for all vehicles, thus enabling them to identify and troubleshoot issues from a centralized location.

Another contemplated feature of the disclosed system, in certain embodiments, is the monitoring of mobile-processor-equipped vehicle activity and the creation of logs for this activity. It is contemplated, depending on the embodiment, that these logs may be viewed at the remote central control center (102), through a user interface location in the equipped-vehicle, or at another computer system. In one embodiment, this log creation will occur in real-time via transfer of the vehicle activity data through the network to the remote central control center (102) or other computer system. In some embodiments, it is contemplated that the downloaded logs will be saved on the remote central control center server (102) and will be accessible from other networked workstations and by authorized personnel via e-mail or some other data sharing service known to those of ordinary skill in the art.

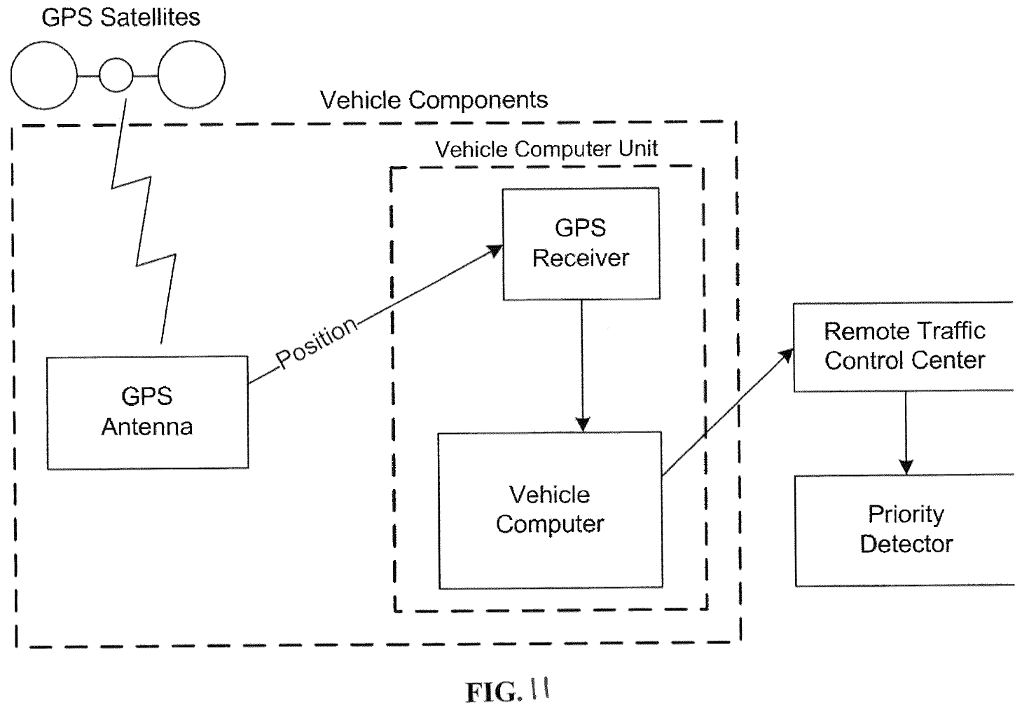

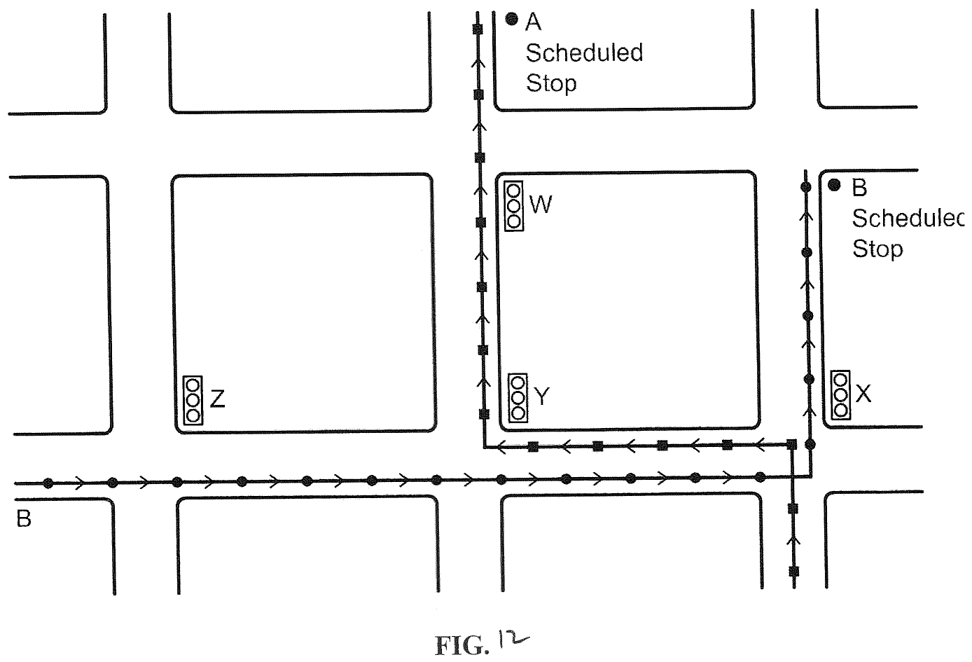

In the embodiment of the ETA traffic control system in which the system is centralized, the communication and information exchange between the components of the disclosed ETA traffic control system generally functions as follows. Either the GPS receiver of the mobile-processor (101) located in the mass transit vehicle, through inputs received from an applicable satellite system, or the camera system (115), determines the speed, direction, velocity, and other pertinent geographic and coordinate information for the vehicle in all monitored approaches. This communication chain is depicted in the block diagrams of FIGS. 11 and 12. Then, either constantly or at fixed time intervals, the VCU (101) transmits either the raw applicable geographic and coordinate information for the vehicle (103) or the pre-calculated ETA arrival time to the remote traffic control center (102), as seen in FIG. 11. Next, the remote traffic control center (102) transmits this data to the applicable priority detector units (105) in the traffic grid.

In this way, the centralized system allows for a robust Automatic Vehicle Location (AVL) system that enables monitoring personnel to track vehicle activity in real time while vehicle locations are displayed on integrated maps. Thus, users of the system can designate key events to trigger alarms to notify workers at central locations of certain events. This ability to monitor equipped-vehicle activity and automatically detect driver violations provides a way for traffic grid supervisors to increase safety while holding mass transit operators accountable for running through stop signals (or other identified violations of the traffic grid). It is also contemplated, in certain embodiments, that this AVL interface and monitoring system will also be available in certain embodiments of the localized system, which may use a mobile-processor (101) or VCU. In these embodiments, a user interface in the vehicle (103) itself can allow for real-time monitoring of equipped-vehicles in the grid.

In the embodiment of the centralized ETA traffic control system in which only the location coordinates are sent from the mobile-processor (101) to the remote traffic control center (102), once the coordinate information is received at the remote traffic control center (102), the remote traffic control center (102), based upon the received coordinates, information regarding the schedule of the mass transit system, and information regarding each of the traffic light signals in the system, determines if the ETA for the mass transit vehicle (103) at the next stop or waypoint is on its schedule. In one embodiment, this transmission of coordinate information will be constant as long as the vehicle (103) is within the applicable range. The remote traffic control center (102) then determines whether the mass transit vehicle (103) is ahead, on, or behind schedule. If the mass transit vehicle (103) is on schedule, in one embodiment of the system no further action will be taken other than continued monitoring. If the mass transit vehicle (103) is on schedule, the system will still determine, based on other inputs into the system (such as inputs from other mass transit vehicles (103) traveling in the grid) if a future delay on the vehicle's scheduled route is likely. If the mass transit vehicle (103) is behind schedule, the remote traffic control center (102) will determine which phases of which traffic signal in the system need to be modified, and in what fashion they need to be modified, to attempt to get the mass transit vehicle (103) back onto schedule with the least amount of disruption to the overall traffic flow. Alternatively, the system may allow another mass transit vehicle (103) that is behind schedule to get on schedule at the expense of one moving ahead of schedule. Once the corrective action determination is made at the remote traffic control center (102), phase change signals are sent from the remote traffic control center (102) to the respective priority detectors (105). These phase change signals are then sent from the priority detector units (105) to the signal controllers (106) to modify the traffic light phases of the respective intersection in the manner necessary to get the mass transit vehicle (103) back onto schedule.

The priority controller based system, where there is no central control, will generally operate along similar lines. However, the determination of which lights to alter is generally made at each individual signal, and the signals may prepare for an alteration that is not implemented because it is no longer necessary based on what other signals have already done. In a still further embodiment, only the last signal will assume any priority adjustment is necessary, and will prepare for that adjustment, adapting the specifics of it as information becomes available from the vehicle (103) reaching different ETAs from interaction with prior signals. A system whereby the signals make independent decisions is generally preferred if there is no central control grid system (and thus no universal system to be disrupted) and where the individual signals each make their own determinations already. For example, if a light will only turn red when a vehicle (103) is detected at a particular cross street (and will do so very quickly), the detection of both the vehicle (103) in the cross street and a behind schedule mass transit vehicle (103) on the main street, can result in the signal delaying the cross street traffic to avoid hampering the mass transit vehicle (103) further.

Notably, in both the vehicle-centered and centralized embodiments of this system, the traffic signals generally will continue to display normal sequences from green to yellow to red. What is often modified in the present systems is the period of time each sequence or phase is displayed. For example, if the overall system determines that the mass transit vehicle (103) needs to hit a red light at traffic light A and a green light at traffic light B in order to get back on schedule without disrupting the traffic flow, even if this actually delays the vehicle (103) further at light A, the priority detectors (105) at each of the traffic lights will receive signals from the remote traffic control center (102) commanding them to adjust the phases at each of their traffic lights in such a manner. As such, the present ETA traffic control system controls the phases of the traffic lights in the system based on the movement of equipped mass transit vehicles (103) in the control grid, modifying the phases of each of the traffic lights in the system in order to ensure that each of the mass transit vehicles (103) reaches each of its scheduled stops essentially on time.

The following offers an example of how the disclosed system would be utilized in the embodiment which utilizes a remote traffic control center and the impact it would have on the overall traffic patterns of the grid it controls. As depicted in FIG. 12, in this hypothetical example, there are two mass transit vehicles (103): vehicle A and vehicle B. Both vehicle A and vehicle B have specific scheduled routes. Both vehicle A and vehicle B have to travel through 3 traffic light intersections before they reach their next scheduled stop. In this hypothetical example, the coordinate information for vehicle A and vehicle B is received at the remote traffic control center (102) from each vehicle's respective mobile-processor (101). Then, the remote traffic control center (102), based upon the received coordinates, information regarding the schedule of the mass transit system, and information regarding each of the traffic light signals in the system, determines the ETA for each of the mass transit vehicles (103) at the next stop on their respective schedules.

In this hypothetical, the remote traffic control center (102) determines that the ETA for vehicle A is three minutes ahead of schedule and the ETA for vehicle B is two minutes behind schedule. From the information regarding the maps of the routes in the grid, the system is able to determine that the routes of vehicle A and vehicle B overlap for two traffic lights. Further, from the information regarding the traffic light signals in the system, the remote traffic control center (102) is able to determine that the default phase change timing for each of the traffic lights in the grid. From this information, the remote traffic control center (102) is able to determine in what manner the phases of the traffic lights in the grid need to be modified in order to get both vehicle A and vehicle B vehicle back onto schedule.

Further, in this hypothetical, the system determines that if it alters the phases of lights Z, Y, and X to allow for vehicle B to travel through these intersections without incurring a red light, vehicle B will get back onto schedule. The system also determines that if it lets vehicle A turn left at traffic light X and holds vehicle A at traffic light Y with a red light (until vehicle B travels by), vehicle A will no longer be ahead of schedule (but will still be on schedule) while vehicle B can still go through light X on green as vehicle A has cleared the intersection before it needs to change. Thus, this pattern is implemented by the system as the best methodology to maintain schedules.

In a system without central control, light Z would generally give priority to vehicle B to help it get back on schedule making sure it had a green light. Light X may do nothing for vehicle A as it is ahead of schedule and does not need priority treatment. As these actions could alter the relative ETA of the vehicles, Light Y may take into account both approaching vehicles (103) and any ETA change based on the effects of lights X or Z (for instance if A is now behind schedule because it did not get to turn at light X without waiting or if A is still ahead and B is still behind). It can then determine that A should be allowed to turn before B can go straight (or visa versa) depending on the impact on each vehicle. This determination may also take into account the possibility that the later light (W or X) of the appropriate vehicle (A or B) can assist to get them back on schedule if the current light Y action results in a delay to one of them.

As demonstrated by this example and the description offered above, ETA traffic control system allows for the free transmission of signals and information between and among the components of the system. Among other functions, this allows for the: 1) configuring of the priority detectors (105) remotely without traveling to each intersection to connect directly to the detectors (105); 2) retrieving of activity logs remotely; 3) monitoring of the specific priority detector (105) activity from the remote traffic control center (102) (in the embodiment in which the system is centralized); 4) remote monitoring of the priority detectors (105) to verify they are working properly; and 5) the connecting of vehicle computer units or mobile-processors (101) to laptop computers for system set-up or log retrieval (as depicted in FIG. 11).

Further, in the centralized embodiment of the system, the remote traffic control center (102) generally functions to: 1) receive coordinate data from each of the respective vehicle equipment units or mobile-processors (101) in the system; 2) store data and information related to the schedules of mass transit vehicles in the system; 3) store data regarding the location and default phase systems of each of the traffic lights in the system; 4) determine the ETA for each mass transit vehicle (103) in the system at designated points along its scheduled route dependent upon the GPS coordinate data or camera system (115) data received; 5) determine how the phases of the traffic lights in the system need to be changed or manipulated in order to keep a mass transit vehicle (103) on its defined schedule; and 6) modify the phases of the traffic lights in the system by sending priority control signals to the priority detectors (105) in the system to modify the phases in order to keep mass transit vehicles in the system on schedule.

In sum, in the disclosed system the phases of the traffic lights in the grid are controlled and modified in accordance to the coordinates and ETA calculations of the mass transit vehicles traveling in the grid or otherwise traveling through a predetermined route on a schedule. Thus, the ETA system's overall focus may be on the efficient and smooth operation of traffic flows in a series of signal lights to a later defined point related to a vehicle's route or in the entire grid system, not simply giving priority to a particular privileged vehicle that comes into a detection zone preceding a specific signal light (although such systems can operate in conjunction with the systems here, and can also utilize the ETA calculation as part of the priority determination). Accordingly, the benefits of the ETA system can be numerous.

First, ease of installation. The ETA traffic control system handles EVP, TSP, and ETA seamlessly and without the requirement of major additional equipment. Thus, the ETA traffic control system can coexist with currently implemented systems without disrupting priority response for emergency vehicles or signal coordination for efficient current grid flow. Second, reliability. Wireless communication is generally not hampered by adverse weather conditions and is not limited to clear line-of-sight paths. Further, the location and activity data in the system is sent through secure radio channels and secure Ethernet connections. Moreover, camera-based location capabilities allow for coverage even in the absence of satellite-based location data. Third, flexibility. The agencies can reconfigure the system as needed. System edits may include (but are not limited to): time-point changes per-intersection approach, detection-zone settings for specific vehicles (to allow for route changes), and vehicle priority levels, amongst other things. The system also allows for different headway amounts (and acceptable variances) to be assigned along different paths of the corridor and for different routes. Fourth, precision and accuracy. Satellite-based or camera-based location data (or even data from other location sources) provides essentially continuous vehicle-position accuracy even in unfavorable urban environments. Fifth, timeliness. Vehicle positions in the system are updated on the map either in the vehicle, at the remote central control center or at secondary control centers very quickly. This enables dispatchers to proactively respond to potential issues quickly. Finally, the ETA traffic control system disclosed herein will improve schedule adherence by requesting priority only when specific conditions are met.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “cylindrical” are purely geometric constructs and no real-world component or relationship is truly “cylindrical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A system for determining a location of a vehicle within a traffic grid, the system comprising:
a vehicle computer unit installed in a vehicle, said vehicle computer unit including a camera;
a priority detector unit communicatively coupled to a signal light controller at an intersection within said traffic grid; and
a wireless network connecting said vehicle computer unit with said priority detector unit;
wherein said vehicle computer unit uses said camera to determine said vehicle's position by:
imaging a unique landmark and determining said vehicle is on a road segment adjacent said intersection coupled to said signal light controller because of said unique landmark being imaged;
imaging a known object within close vicinity of said intersection, said known object being one of a plurality of similar known objects which are present at a plurality of intersections, each of said known objects having a generally identical known size and shape and having a generally identical position relative to said intersection to which it is in close vicinity;
calculating from said imaging of said known object, a distance from said known object based on an imaged size of said known object in said camera image; and
determining from said distance said location of said vehicle on said road segment.

2. The system of claim 1, further comprising determining said vehicle's velocity by evaluating a change in said imaged size of said known object over time.

3. The system of claim 2, further comprising calculating said vehicle's estimated time of arrival at said intersection based on said position and said velocity of said vehicle.

4. The system of claim 3, wherein said vehicle computer unit requests said priority detector unit modify a signal light at said intersection based on said vehicle's estimated time of arrival at said intersection.

5. The system of claim 2, further comprising calculating said vehicle's estimated time of arrival at a location beyond said intersection based on said position and said velocity of said vehicle.

6. The system of claim 5, wherein said vehicle computer unit requests said priority detector unit modify a signal light at said intersection based on said vehicle's estimated time of arrival at said location beyond said intersection.

7. The system of claim 6, further comprising:
a remote traffic control center, wherein the remote traffic control center is communicatively attached to the wireless network;
wherein the vehicle computer unit transmits information chosen from the group consisting of: the vehicle's position, direction, velocity, and estimated time of arrival at said location beyond said intersection to said remote traffic control center;
wherein said remote traffic control center determines a plurality of signal light controllers within said traffic grid which need to be modified for vehicle to reach said location beyond said intersection at a specified time; and
wherein said remote traffic control center sends a signal to one or more of the plurality of signal light controllers to request modification of an associated signal light.

8. The system of claim 7, wherein said vehicle is a mass transit vehicle, said specified time is a scheduled time, and said location beyond said intersection is a service stop for picking up passengers of said mass transit vehicle.

9. The system of claim 7, wherein said vehicle is an emergency vehicle, said specified time is as soon as possible, and said location beyond said intersection is a destination of said emergency vehicle.

10. The system of claim 6, wherein after said signal light is modified, said velocity is recalculated to determine if said velocity has changed.

11. The system of claim 1, wherein said vehicle is a mass transit vehicle.

12. The system of claim 1, wherein said vehicle is an emergency vehicle.

13. The system of claim 12, wherein said vehicle computer unit requests said priority detector unit modify a signal light at said intersection because said vehicle is said emergency vehicle.

14. The system of claim 1, wherein said known object is a signal light for intersections.

15. The system of claim 1, wherein said known object is a traffic sign.

16. The system of claim 15, wherein said traffic sign is a stop sign.

17. The system of claim 1, wherein said known object is a pole holding a signal light at intersections.

18. A method for determining a location of a vehicle within a traffic grid, the method comprising:
providing a vehicle computer unit installed in a vehicle, said vehicle computer unit including a camera;
providing a priority detector unit communicatively coupled to a signal light controller at an intersection within said traffic grid; and
providing a wireless network connecting said vehicle computer unit with said priority detector unit;
said vehicle computer unit using said camera to determine said vehicle's position by:
imaging a unique landmark and determining said vehicle is on a road segment adjacent said intersection coupled to said signal light controller because of said unique landmark being imaged;
imaging a known object within close vicinity of said intersection, said known object being one of a plurality of similar known objects which are present at a plurality of intersections, each of said known objects having a generally identical known size and shape and having a generally identical position relative to said intersection to which it is in close vicinity;
calculating from said imaging of said known object, a distance from said known object based on an imaged size of said known object in said camera image; and
determining from said distance said location of said vehicle on said road segment.

19. The method of claim 18, further comprising determining said vehicle's velocity by evaluating a change in said imaged size of said known object over time.

20. The method of claim 19, further comprising calculating said vehicle's estimated time of arrival at said intersection based on said position and said velocity of said vehicle.
